(19) United States
(12) Patent Application Publication
(10) Pub. No.: US 2014/0026729 A1
(43) Pub. Date: Jan. 30, 2014

(54) Return device for returning punch head of paper punch

(71) Applicant: Tsung Wen HUANG, Chang Hua County (TW)

(72) Inventor: Tsung Wen HUANG, Chang Hua County (TW)

(21) Appl. No.: 13/785,031

(22) Filed: Mar. 5, 2013

(30) Foreign Application Priority Data
Jul. 26, 2012 (TW) 101214437

(51) Int. Cl. B26F 1/02

(52) U.S. Cl. CPC B26F 1/02
USPC 83/588

(57) ABSTRACT

A paper punch includes at least one punch head unit connected to a base and the at least one punch head unit has at least one punch head located therein. At least one resilient plate is cooperated with the at least one punch head. The first end of the at least one resilient plate is fixed to the at least one punch head unit and the second end of the at least one resilient plate is bent for form a connection end. An operation portion is connected between the first end and the second end of the at least one resilient plate. The connection end contacts a lower lateral side of a front pin extending transversely through the at least one punch head. The at least one resilient plate brings the at least one punch head upward after each punching action. The at least one resilient plate occupies less space and is easily installed. The paper punch is safe and easily assembled.

### FIELD OF THE INVENTION

The present invention relates to a paper punch, and more particularly, to a return device for returning the punch head of a paper punch.

### BACKGROUND OF THE INVENTION

The conventional paper punch is used to punch holes along one side of the paper sheets which are easily collected by file folders. FIG. 8 shows one of the conventional paper punches and comprises a base 20 with an operation area 21 on which the paper sheets to be punched are put. Two punch head units 22 are located on the top of the base 20 and each punch head unit 22 has a spring 23 and a punch head 24. The spring 23 is mounted to the punch head 24 and two ends of the spring 23 are in contact with the punch head unit 22 and the punch head 24. The top of the punch head 24 extending from the top of the punch head unit 22 is connected with a mount 25 and a handle 26. The mount 25 is pivotably connected to the punch head unit 22 by a rear pin 27. By pushing the handle 26 to compress the mount 25, the mount 25 is pivoted about the rear pin 27 so that the punch head 24 moves toward the operation area 21 to punch holes through the paper sheets. When releasing the handle 26, the springs 23 bring and the punch heads 24 and the handle 26 back to their initial positions.

However, the spring 23 is mounted to the outside of the punch head 24 so that the space in the punch head unit 22 for receiving the spring 23 and the punch head 24 is increased, and this makes the punch bulky and the manufacturing cost increases.

The springs 23 are located upright so that when installing the springs 23, the reaction forces of the springs 23 make the assembling processes be difficult and inconvenient. The users have to apply significant force to overcome the spring forces to punch holes.

FIG. 9 shows another conventional paper punch wherein each of the punch heads 24 is cooperated with a torsion spring 28 which occupies less space than the spring 23 in the previous example. The torsion spring 28 is mounted to the rear pin 27 of the mount 25 and the two extensions 29 of the torsion spring 28 are respectively connected to the punch head unit 22 and the inside of the mount 25. Because the force required to press the two extensions 29 toward each other is so large that when assembling the paper punch, the torsion spring 28 is difficult to be installed in the punch head unit 22. When in maintenance, the torsion springs 28 can pop out at high speed to injure the users.

The present invention intends to provide a paper punch which uses resilient plates to replace the springs of the conventional paper punches to improve the shortcomings of the conventional paper punches.

### SUMMARY OF THE INVENTION

The present invention relates to a paper punch and comprises a base having at least one punch head unit connected thereto and the at least one punch head unit has a slot defined laterally therethrough. At least one punch head extends through the top of the at least one punch head unit and at least one front pin extends through the slot of the at least one punch head unit and the at least one punch head in the at least one punch head unit. At least one mount is mounted to the top end of the at least one punch head and the at least one mount is pivotably connected to the at least one punch head unit. A handle is connected to the at least one mount so as to lower the at least one punch head. At least one return device has at least one resilient plate, and the at least one resilient plate is cooperated with the at least one punch head. The first end of the at least one resilient plate is fixed to a connection portion of the at least one punch head unit and the second end of the at least one resilient plate is bent to form a connection end. An operation portion is connected between the first end and the second end of the at least one resilient plate. The connection end contacts the lower lateral side of the front pin and is lowered with the at least one punch head.

The at least one resilient plate has a bent end so that the different heights between the two ends store the force to bring the at least one punch head upward. The space required for accommodating the at least one resilient plate is much less than that for the springs of the conventional paper punches.

The connection end is fixed to the at least one punch head unit and the connection end is easily installed to the lower lateral side of the front pin. This is benefit when assembling the paper punch.

Even if the at least one resilient plate is broken, because the connection portion is fixed to the at least one punch head unit and the connection end is in contact with the front pin, the broken resilient plate does not injure the users.

Because the connection portion is fixed to the at least one punch head unit and the connection end is in contact with the front pin, the resistant force when pressing the at least one resilient plate is not increased along with the pivoting action to the handle, the users operate the paper punch comfortably.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the paper punch of the present invention;

FIG. 2 is an exploded view to show the paper punch of the present invention;

FIG. 3 is a perspective view, partially removed, of the paper punch of the present invention;

FIG. 4 is a cross sectional view of the paper punch of the present invention;

FIG. 5 is a cross sectional view to show the paper punch of the present invention, wherein the handle is pivoted downward;

FIG. 6 is a cross sectional view of the paper punch of the present invention, wherein two resilient plates are cooperated with each punch head;

FIG. 7 is a cross sectional view to show another embodiment of the installation of the resilient plate of the present invention;

FIG. 8 shows the conventional paper punch wherein the compression spring is installed, and

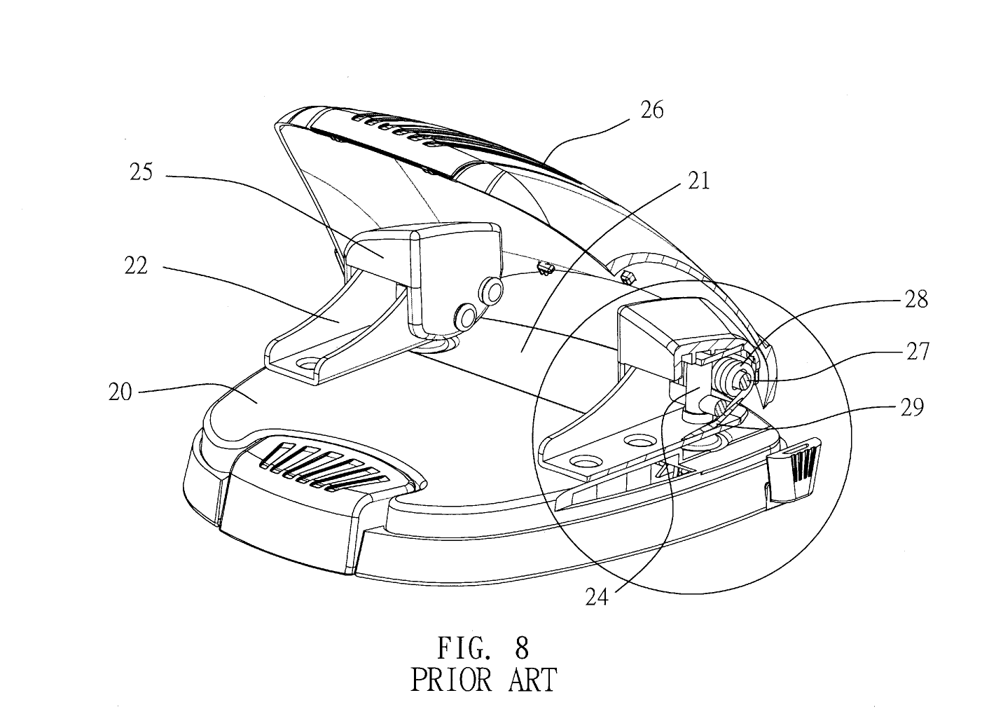

FIG. 9 shows the conventional paper punch wherein the torsion spring is installed.

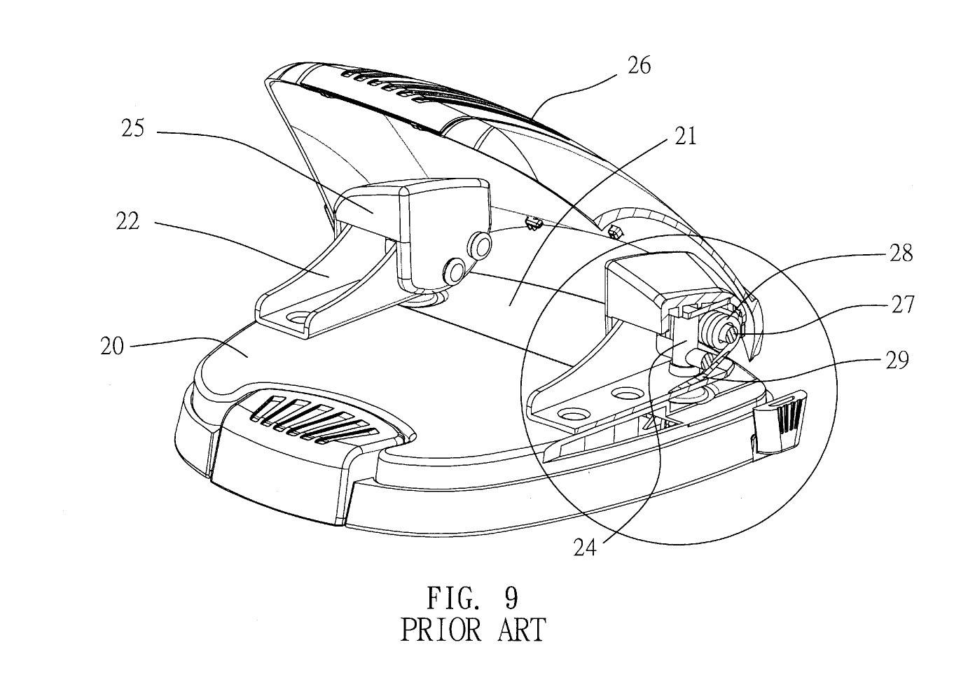

### DETAILED DESCRIPTION OF THE PREFERRED EMBODIMENT

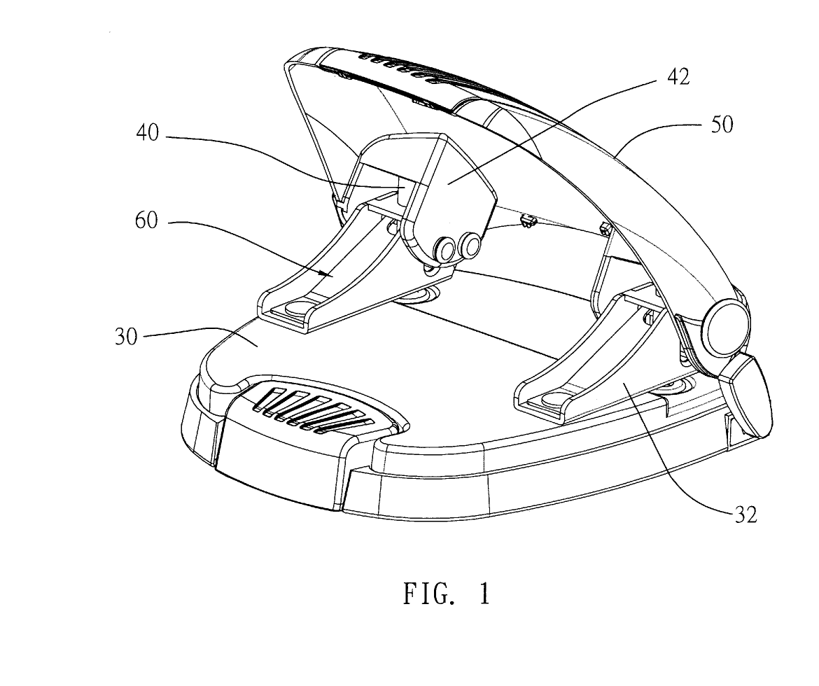

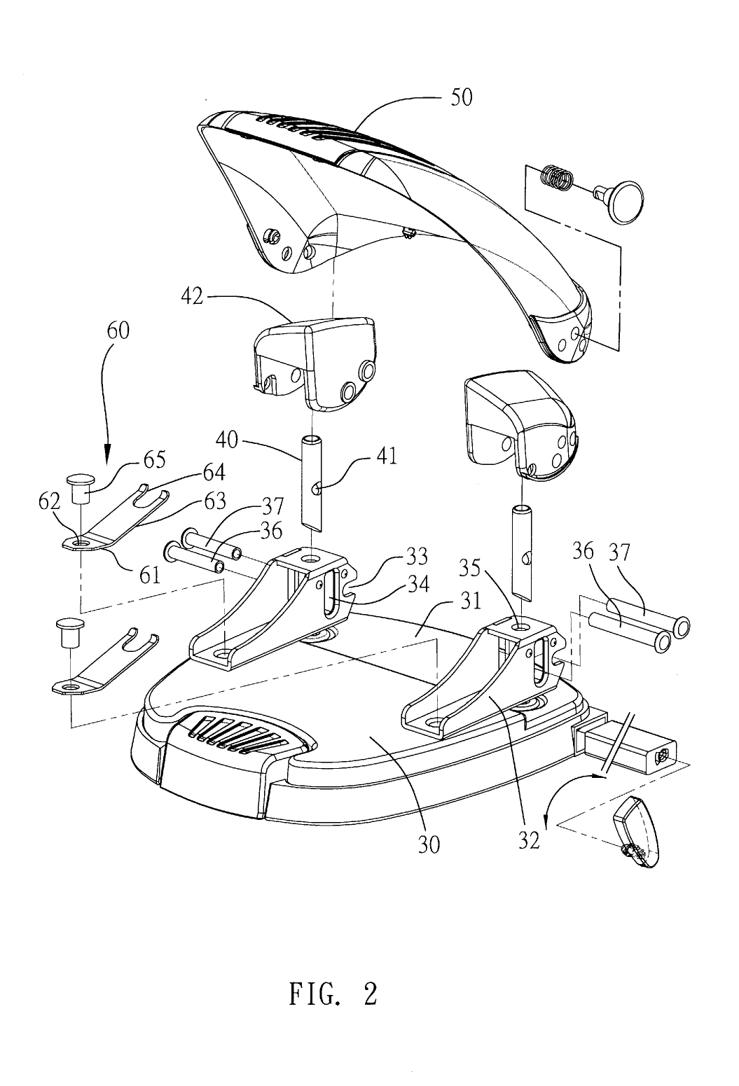

Referring to FIGS. 1 and 2, the paper punch of the present invention comprises a base 30 having two punch head units 32 connected thereto, and a handle 50. The paper punch of the present invention may be used to punch one hole, two holes or three holes. In this embodiment, the paper punch is used to punch two holes. The base 30 has a stepped surface which is the operation area 31 on which paper sheets to be punched are put. Each punch head unit 32 has notch 33 defined in a rear side thereof and a slot 34 defined laterally through each of two sidewalls thereof. A passage 35 defined through the top of each of the punch head units 32 and a punch head 40 extends into the passage 35 from the top of each of the punch head units 32. Each punch head 40 has a connection hole 41 defined in the mediate portion thereof two front pins 36 respectively extend through the slots 34 of the punch head units 32 and the connection holes 41 of the punch heads 40 in the punch head units 32.

Two mounts 42 are mounted to two respective tops of the two punch heads 40 and the two mounts 42 are respectively and pivotably connected to the punch head units 32 by extending two respective rear pins 37 through the mounts 42 and the notches 33.

A handle 50 is connected to the two mounts 42 so that when the handle 50 is pivoted downward, the mounts 42 are pivoted about the notches 33 and the punch heads 40 are lowered to punch holes.

Two return devices each have a resilient plate 60 and the two resilient plates 60 are cooperated with the two punch heads 40. Each of the two resilient plate 60 are an elongate plate and the first end of each resilient plate 60 is a connection portion 61 which is secured to the punch head unit 32, and the second end of each of the resilient plates 60 is bent to form a connection end 64. A hole 62 is defined through the connection portion 61 of each of the resilient plates 60 and a fixing member 65 extends through the hole 62 to fix the resilient plate 60 on the punch head unit 32 and the base 30. The connection end 64 contacts the lower lateral side of the front pin 36 and is lowered with the punch head 40 when the handle 50 is pivoted downward. An operation portion 63 is connected between the first end and the second end of each of the resilient plates 60. The different heights between the first end and the second end of each of the resilient plates 60 generate a resilient force when the two ends are moved toward each other.

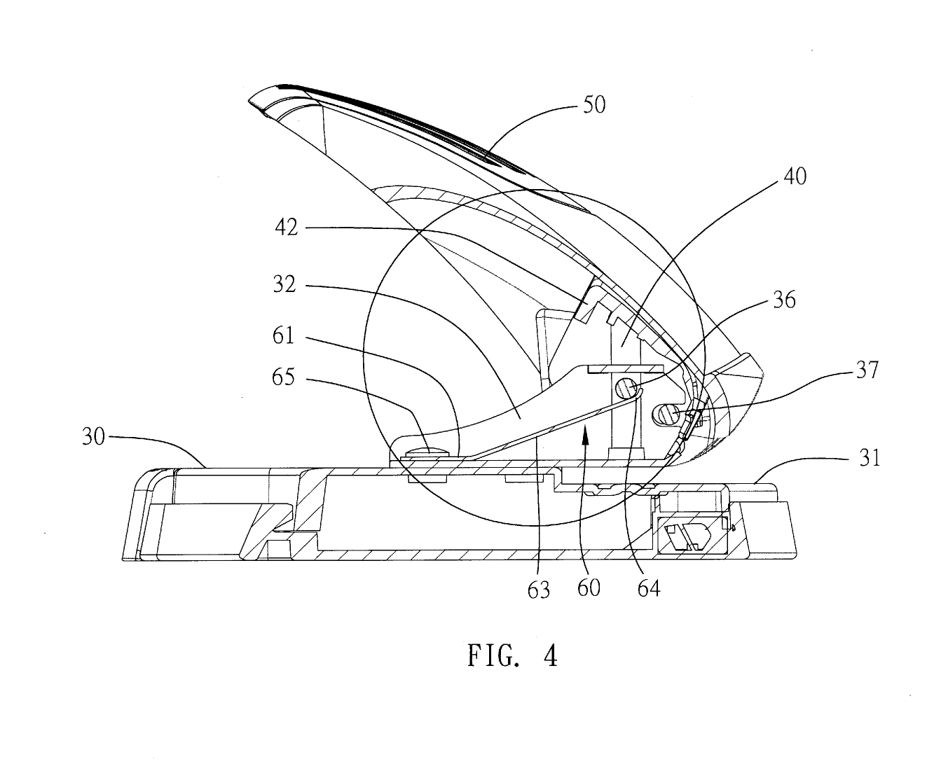

Referring to FIGS. 2 and 4, the two punch head units 32 are fixed to the top of the base 30 and the connection end 64 of each of the resilient plates 60 is a U-shaped end which is communicates with the passage 35 so that the punch head 40 extends through the passage 35 and the U-shaped end of the resilient plate 60. The front pin 36 extends through the slots 34 of the punch head unit 32 and the connection hole 41 of the punch head 40 in each punch head unit 32. The connection end 64 contacts the lower lateral side of the front pin 36. The mount 42 is pivotably connected to the notch 33 by the rear pin 37, and pivotably connected to the handle 50.

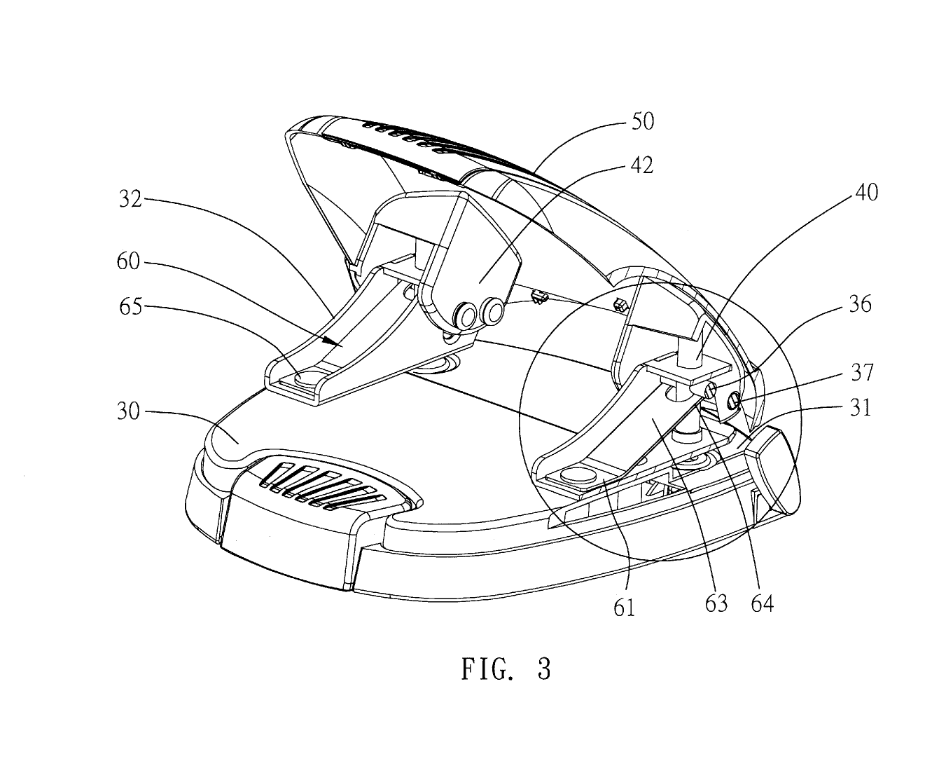

As shown in FIGS. 3 and 4, when the handle 50 is not yet pivoted downward, the resilient plates 60 are fixed to the punch head units 32 by the connection portions 61, and the connection end 64 contacts the lower lateral side of the front pin 36. The operation portions 63 of the resilient plates 60 are inclined upward.

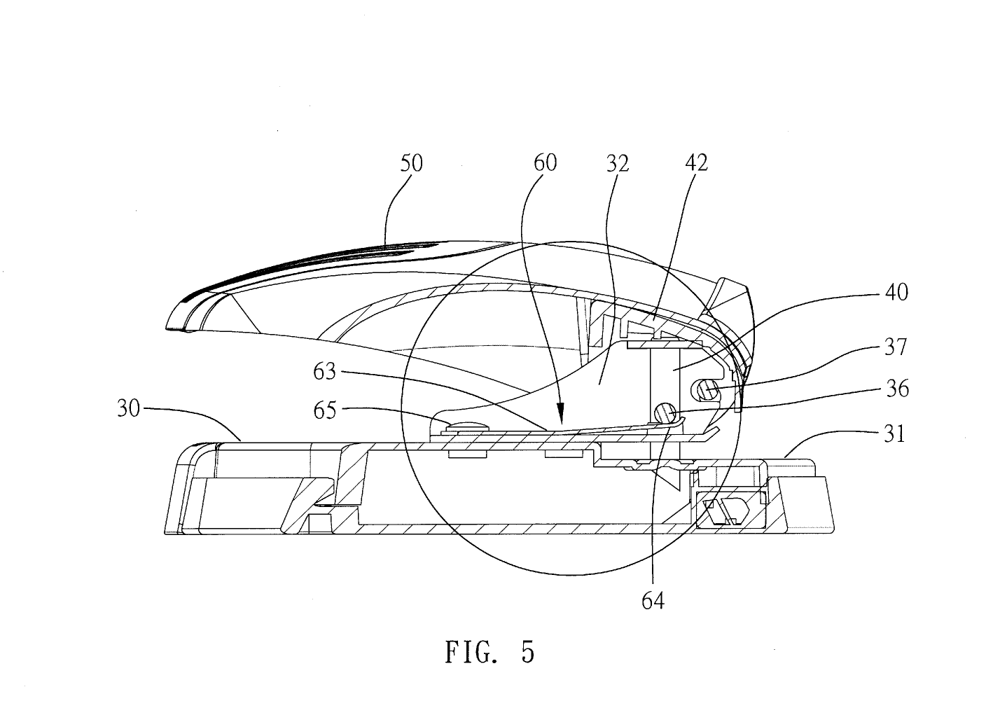

As shown in FIGS. 4 and 5, when the handle 50 is pivoted downward, the mounts 42 are pivoted about the rear pins 37 and the punch heads 40 are pushed by the mounts 42 such that the tips of the punch heads 40 are lowered. The front pins 36 are lowered and push the operation portions 63 of the resilient plates 60 downward. The punch heads 40 punch the paper sheets on the operation area 31. When releasing the handle 50, the forces stored in the operation portions 63 bring the punch heads 40, the mounts 42 and the handle 50 upward, until the front pins 36 contact the upper end of the slots 34 of the punch head units 32.

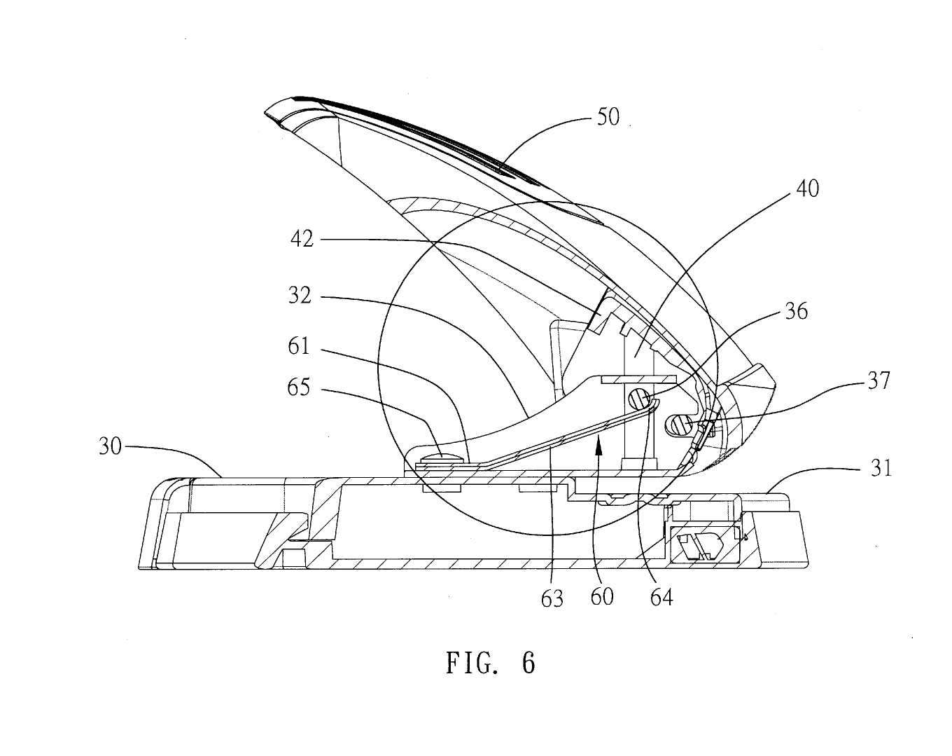

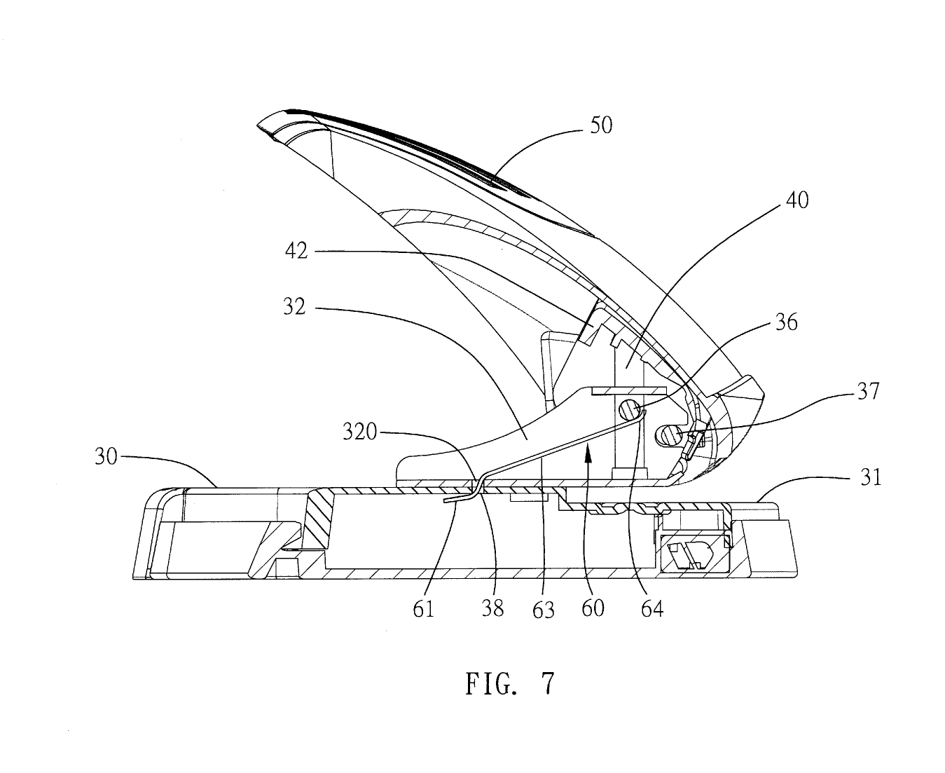

FIG. 6 shows that each punch head 40 is cooperated with two resilient plates 60 so as to provide sufficient resilient force so as to bring the punch heads 40, the mounts 42 and the handle 50 upward. FIG. 7 shows another embodiment of the installation of the resilient plate 60 of the present invention, wherein each of the punch head units 32 has a hole 320 and the base 30 has two securing holes 38 which are respectively located in alignment with the holes 320 of the punch head units 32, and the connection portions 61 of the resilient plates 60 are securely engaged with the aligned holes 320 of the punch head units 32 and the securing holes 38 of the base 30.

The use of the resilient plates 60 requires less space in the punch head units 32 and the installation for the resilient plates 60 is easy.

It is noted that the embodiment disclosed above has two punch head units 32, however, one punch head unit or more than two punch head units are also deemed as part of the invention.

While we have shown and described the embodiment in accordance with the present invention, it should be clear to those skilled in the art that further embodiments may be made without departing from the scope of the present invention.

What is claimed is:

1. A paper punch comprising:
a base having at least one head unit connected thereto and the at least one punch head unit having a slot defined laterally therethrough;
at least one punch head extending through a top of the at least one punch head unit, a front pin extending through the slot of the at least one punch head unit and the at least one punch head in the at least one punch head unit;
at least one mount mounted to the top of the at least one punch head and the at least one mount pivotably connected to the at least one punch head unit;
a handle connected to the at least one mount so as to lower the at least one punch head, and
at least one return device having at least one resilient plate, the at least one resilient plate being cooperated with the at least one punch head, a first end of the at least one resilient plate being a connection portion which is secured to the at least one punch head unit and a second end of the at least one resilient plate being bent to form a connection end, an operation portion connected between the first end and the second end of at least one the resilient plate, the connection end contacting a lower lateral side of the front pin and being lowered with the at least one punch head.

2. The paper punch as claimed in claim 1, wherein a hole is defined through the connection portion of the at least one resilient plate and a fixing member extends through the hole and fixes the at least one resilient plate on the at least one punch head unit and the base.

3. The paper punch as claimed in claim 2, wherein the connection end of the at least one resilient plate is a U-shaped end.

4. The paper punch as claimed in claim 1, wherein the at least one punch head unit has a hole and the base has at least one securing hole which is located in alignment with the hole of the at least one punch head unit, the connection portion of the at least one resilient plate is securely engaged with the hole of the at least one punch head unit and the at least one securing hole of the base.
